(19) United States
(12) Patent Application Publication
(10) Pub. No.: US 2019/0057676 A1
(43) Pub. Date: Feb. 21, 2019

(54) PLAY BY NUMBER METHOD AND SYSTEM OF NOTATION, TRANSCRIPTION AND INSTRUCTION FOR KEYBOARDS

(71) Applicant: Carl Edward Johnson, Rancho Santa Margarita, CA (US)

(72) Inventor: Carl Edward Johnson, Rancho Santa Margarita, CA (US)

(21) Appl. No.: 15/678,041

(22) Filed: Aug. 15, 2017

(51) Int. Cl. G10G 1/02; G09B 15/00; G09B 5/06; G10G 1/04

(52) U.S. Cl. CPC G10G 1/02; G10G 1/04; G09B 5/06; G09B 15/003

(57) ABSTRACT

In the Play By Number Music Notation System a grand staff is placed on top with multiple keyboard images aligned underneath. Each keyboard image represents one “CHUNK” of the song (a melodic phrase) and is identified with a letter (A, B, C, . . . ) on the right side and numbers on the left (01, 02, 03 . . . ) to show the sequence each chunk is played. Numbers are placed on the white keys indicating the order the keys are pressed (i.e. 1-12 . . . ) and the duration by using the familiar plain, bold, bold-italic from printing to indicate short, long and longer. When numbers are placed on the line between two keys this indicates you move up the line and play the black key. No need to indicate sharp(#) or flat(b). One simple follows the numbers pressing each key in sequence until the chunk is done.

### FIELD OF INVENTION

The present invention relates to a novel way to represent music on paper (music notation). More particularly the invention relates to the placement of numbers on illustrations of keyboards indicating the order of keys to be pressed with numbers printed in different style (normal/plain, bold and bold italic) to indicate how long to hold the key (short, long and longest).

REFERENCES CITED
US PATENT DOCUMENTS

| | | |
|---|---|---|
| 2,506,451 | May 2, 1950 | Hammond (44 Key Keyboard) |
| 7,767,895 B2 | Aug. 3, 2010 | Johnston (Music Notation |
| | | System) |
| 7,288,705 B1 | Oct. 30, 2007 | Nelson (Method for Teaching |
| | | Musical Notation and Composition |
| 2,406,946 | Sep. 3, 1946 | Firestone (Music Teaching Device) |
| 6,124,540 | Sep. 26, 2000 | Lotito (Musical Notation System) |
| 6,288,316 B1 | Sep. 11, 2001 | Fajardo (Musical Notation System) |
| 6,388,182 B1 | May 14, 2002 | Bermudez (Method and Appratus |
| | | for Teaching Music) |
| 8,916,760 B1 | Dec. 23, 2014 | West et al. (Music Notation |
| | | System) |
| 8,835,737 B2 | Sep. 16, 2014 | King (Piano Tablature System and |
| | | Method) |
| 7,241,945 B2 | Jul. 10, 2007 | Egan (Morpheus Music Notation |
| | | System) |
| 7,041,891 B2 | May 9, 2006 | Smith Carter (Choral Keyboarding |
| | | Non-Note Reading |
| | | Methodology) |
| 6,870,085 B2 | Mar. 22, 2005 | MacCutcheon (Music Teaching |
| | | System and Method) |

US PATENT APPLICATIONS

| | | |
|---|---|---|
| US 2008/0202318 | Aug. 28, 2008 | Mataele (Method and System for |
| A1 | | Music Notation) |

### Commercial Products

### Baldwin 1969 Organ (FIG. 26)

### Minimoog Model D Synthesizer (FIG. 27)

### Moog Liberation Synthesizer (FIG. 28)

### Yamaha Portasound PC-100 (FIG. 29)

### Casiotone MT-36 (FIG. 30)

### Casio SA-76 (FIG. 31)

### Willis Keyboard and Reference Chart (FIG. 46)

### Websites

http://www.wikihow.com/Read-Piano-Tabs (FIG. 33)
https://www.scribd.com/doc/48794794/PLAY-THE-PIANO-BY-NUMBERS-OR-LETTERS (FIG. 36)

### BACKGROUND

Sheet music was developed to provide a method of reproducing music on paper. An accomplished musician can look at a piece of sheet music and play the song perfectly as a composed and performed. There is no need for the musician to have previously heard the song before because the intricate instructional symbols (#, b, ̂, :∥, ∥:, . . . ) and Latin and Italian phrases (D.C. al fine, fortissimo, . . . ) allow them to play it perfectly.

In the 1800's the music publishing industry flourished in the US and UK. Between 1800 and 1825 over 10,000 titles of music were printed. A home piano, harmonium, melodean, or reed organ was a symbol of middle class success in America's cities. In the frontier the railroads shipped Estey Reed Organs, Chickering Pianos, Cornish Corinthian Orchestral Organs or any one of a hundred styles of organs from the Mason & Hamlin Organ & Piano Company catalog to the parlors of the west. Children of cultured families were expected to learn to play and to perform on command. Sometimes visitors would bring the latest sheet music from afar and expect that someone in the house could play the song.

By the 1880's the New York Music Publishing Industry became known as Tin Pan Alley. They started promoting new music by placing samples (usually just a few bars) in magazines, news papers, and even on the backs of sheet music to entice buyers. Most pianos has standardized on 88 keys (FIG. 23) by this time. By 1910 over 25,000 pieces of music were copyrighted per year. This led to the standardized sheet music industry we have today designed with three things in mind:

Easy to print a complete song on 2-3 pages (to allow room for cover an and advertising).

Designed for a trained musician (who reads sheet music) to use without any instruction.

Designed to be used without having heard the song before.

With the advent sound recording and the sale of pre-recorded cylinders for the Edison Phonograph and later records for the Gramophones the seeds were sewn to change America from a nation of musicians to a nation of listeners. The Library of congress has over 10,000 recordings made by the Victor Talking Machine Company between 1901 and 1925. While families still had a piano or organ it increasing became something old people did as younger people wanted to relax and listen to music, not make it. While it used to be every child was expected to play an instrument now only the few practiced long enough to learn sheet music and master the keyboard so they were called “talented”. Most people who tried to learn the piano would give up when the records easier to play. Not helping matters was a generation of piano teachers who learned in the old school method and harshly insisted that music be “played as written!”.

The radio industry broadcast the latest music coast to coast so why bother to learn when we always have something new on the station. Even the President came into our parlors with the latest news on the Great Depression or later the news on World War II from around the globe. The radio sometimes rested on the old reed organ in the corner.

After World War II the movement to the suburbs and the birth of Rock & Roll young Americans taste shifted to the Guitar. Older Americans found a new keyboard to love, the Hammond Tonewheel Organ (FIG. 24). Hammond discovered you really only needed 44 keys to play most songs. A revised Grand Staff illustrates how 44 keys do indeed cover the required octaves for most songs (FIG. 25). The invention of the offset dual 44 key keyboard configuration became the standard. But while older Americans bought these electronic spinet organs from Hammond, Allen, Conn, Gulbransen, Lowrey and Baldwin (FIG. 26) kids wanted a guitars from Gibson, Fender or Rickenbacker. The music generation gap began with fret instruments (Acoustical Guitars & Basses, Electrical Guitar and Basses and Ukulele) being “in” and keyboard instruments (Pianos, Organs) being out. The 44 key keyboard organ configuration found a home with synthesizers. In the 1970's and the 1980's the Minimoog Model D Synthesizer (FIG. 27) was on stage with bands from ABBA to Frank Zappa. The Moog Liberation Keytar (FIG. 28) was used by DEVO and even James Brown and. The electronic keyboard makers discovered the 44 key sweet spot with such keyboard as the Yamaha Portasound PC-100 (FIG. 29), the Casiotone MT-36 (FIG. 30) and even todays Casio SA-76 (FIG. 31) but for the most part guitar was king in popular music.

A big cause of this was the emergence of Guitar Tabs and Chords in sheet music (FIG. 22). This new type of sheet music showed a potential guitar player what and where the strings are held down then one strum and you have a chord. Without any musical training you could pick up a guitar and look at the guitar chord symbol at the top of sheet music and start playing. More advanced players would look at the TAB portion of this sheet music and pick each individual strings. Professional musicians would record a song and within weeks the guitar tabs would be available on-line showing exactly how they made the sound on the record. Keyboard players would have to wait weeks, months or even years sometimes to get sheet music for a song or perhaps never get it due to licensing restrictions.

In the past many have tried to remedy the short comings found in traditional sheet music using various methods:

Changing the keyboard was the solution proposed in the 1946 Firestone patent for the Music Teaching Device (FIG. 32). This did away with traditional keyboard and replaced it with a tiered keyboard requiring the replacement of the keyboards you already owned.

Color was a key part of the solution shown on the website wikihow.com. It has an undated article called Read-Piano-Tabs (FIG. 33) that uses colored dots for each note dramatically increasing the cost of printing. The 2007 Nelson Method for Teaching Musical Notation and Composition (FIG. 34) used colored dots with the note letters to be placed on the keyboard and sheet music that consisted of colored dots. The MacCutcheon Music Teaching System and Method (FIG. 35) of 2005 used colored stickers with mnemonics (carrot for the note C, Blue for the note B, etc.) placed on the keys and colored notes on the sheet music. Both of these solutions required you place stickers on all the keys of your keyboard.

Relative numbering of the keys on the keyboard from middle “C” has been tried. The 2006 Smith Carter Choral Keyboarding Non-Note Reading Methodology (FIG. 36) used numbers for the keys (1-7) with 1+, 2+ . . . indicating move up an octave while −1, −2 was move down an octave relying on you to know what number each key is assigned. In 2007 Mason Emerson released a free booklet tided Play The Piano by Numbers or Letters on the web (FIG. 37) that basically replaced the minus one, one, one plus (−1 1 1+) of the Smith Carter Methodology with a dot one, one, one dot (. 1 1 1 .).

Numbering all the keys (1-88) on the piano was the solution of the Egan Morpheus Music Notation System of 2007 (FIG. 38). Sheet music was presented as a series of numbers for each key on the keyboard. Numbered stickers would need to be placed on each key.

Changing the shape of the notes was the solution proposed in the 2000 Lotito Musical Notation System (FIG. 39) where by the note shapes were changed from oval to a diamond for sharps and flattened for the flat notes. In 2014 the West et al. Music Notation System (FIG. 40) changed the note symbols to circles filled in based on the note (crescent for C, dot for D, empty for E, etc. . . . ) adding more complexity.

Renaming the keys in an octave was the solution for some. They are renamed the sharps/flats to “HI JKL” in the 2001 Fajardo Musical Notation System (FIG. 41). The 2008 Mataele Method and System for Music Notation (FIG. 42) renumbered the keys of an octave (1, 2, 3, 4, 5, 6, 7, 8, 9, X, Y, Z).

The most popular numbering method is numbering the fingers of each hand one through five. In 2002 the Bermudez Method and Apparatus for Teaching Music was patented (FIG. 43) where the fingers were numbered 1-5 each hand starting with the thumb and the notation was a line with numbers above or below the line indicating right hand (above) and left hand (below) but in this notation both thumbs have to be on “C” limiting you to a 9 note range. The 2010 Johnston Music Notation System (FIG. 44) used a grid to indicate the notes from the left to right and showed a line for each finger moving down indicating which note to play with each finger which increased the complexity of learning and playing music. Finally in 2014 the King Piano Tablature System and Method (FIG. 45) was released coming close to the guitar tabs by numbering each finger 1-5 with the left hand numbers in a square and the right hand numbers in a circle and showing how to play it on a grid with the columns representing the keys and the rows indicating time.

Numerous reference charts have been developed like Willis Keyboard and Reference Chart (FIG. 46) to help students decipher the relationship between the keyboard and sheet music.

### BRIEF SUMMARY OF THE INVENTION

This invention simplifies learning the keyboard through a new type of music notation. It uses a grand staff aligned with images of keyboards (FIG. 01). Each image of a keyboard has a letter to identify this “chunk” of the song (A, B, C, etc. . . . ) on the right, and one or more numbers on the left to indicate the order the various chunks are played (01, 02, 03, etc. . . . ). Each keyboard image has numbers placed on the white keys starting with 1 to indicate the order keys are pressed. When the number is on the line you press the key above it (the black keys). The numbers are printed in plain, bold and bold-icalic to indicate to press them a short, long or longest amount of time. Lyrics are printed in a box with a dash between each syllable (FIG. 02). When the same number appears on more than one key that means multiple keys are pressed at the same time (FIG. 08-15). Alternately traditional chords may be called out in a box in the form 1-Dm7 meaning play the chord Dm7 the same time you play the note 1 (FIG. 03).

This invention simplifies learning to play by:
Reducing the number of note lengths (Whole, Half, Quarter, Eights, Sixteenth, Dotted Half, Dotted Quarter, Dotted Eights, Dotted Sixteenth) with a system that can be easily understood and is found in word processing (plain, bold and bold-italic) for (short, long and longer) notes.
Eliminates the need to learn shapes and flats (if the number is on the line play the black key)
Can be fully implemented with black and white printing.
Works on any sized existing keyboards without modification.
Does not rely on the ability to read sheet music.
Does not rely on memorizing chords to play music.

### BRIEF DESCRIPTION OF THE DRAWINGS

FIG. 1 shows detailed call outs for a Play By Number notation of a song with lyrics and chords.

FIG. 2 shows the same music in traditional notation and the Play By Number notation side by side.

FIG. 3 shows how to indicate a section is repeated with a text instruction box.

FIG. 4 shows how to Indicate specific MIDI voices [TUBULAR BELLS (MIDI 15)] for sections of the song and an alternate way to indicate chords.

FIG. 5 shows a complete song in the Play By Number notation with the Grand Staff, Song Tide and author, chunks (A, B & C) and the sequence of chunks on the left (01, 02, 03)

FIG. 6 shows a blank Play By Number Notation System Form (Title Page) used to manually notate a song.

FIG. 7 shows a blank Play By Number Notation System Form (Body Page) used for longer songs.

FIG. 8-18 show the method of creating the Play By Number Notation from existing sheet music.

FIG. 19 shows the process of editing the Master Play By Number Notation System Form on a computer for printing.

FIG. 20 shows some simple traditional sheet music.

FIG. 21 shows some very complex sheet music.

FIG. 22 shows traditional sheet music with guitar chords above and guitar tabs below.

FIG. 23 shows the Grand Staff aligned with the 88 key piano keyboard.

FIG. 24 shows the 1950 Hammond with dual 44 key organ keyboards from U.S. Pat. No. 2,506,451.

FIG. 25 shows the Grand Staff aligned with a 44 key organ keyboard.

FIG. 26 shows a 1969 Baldwin with dual 44 key organ keyboards.

FIG. 27 shows a 1970's MiniMoog Model D Synthesizer with a 44 key organ keyboard.

FIG. 28 shows a 1980's Moog Liberation Guitar Style Synthesizer with a 44 key organ keyboard.

FIG. 29 shows a 1980's Yamaha PortaSound PC-100 with a 44 key organ keyboard.

FIG. 30 shows a 1980's Casiotone MT-36 with a 44 key organ keyboard.

FIG. 31 shows a current Casio SA-76 with a 44 key organ keyboard.

FIG. 32 shows the 1946 Firestone Music Teaching Device from U.S. Pat. No. 2,406,946.

FIG. 33 shows the WikiHow Read-Piano-Tabs article.

FIG. 34 shows the 2007 Nelson Method for Teaching Musical Notation and Composition from U.S. Pat. No. 7,288,705 B1.

FIG. 35 shows the 2005 MacCutcheon Music Teaching System and Method from U.S. Pat. No. 6,870,085 B2.

FIG. 36 shows the PLAY-THE-PIANO-BY-NUMBERS-OR-LETTERS booklet.

FIG. 37 shows the 2006 Smith Carter Choral Keyboarding Non-Note Reading Methodology from U.S. Pat. No. 7,041,891 B2.

FIG. 38 shows the 2007 Egan Morpheus Music Notation System from U.S. Pat. No. 7,241,945 B2.

FIG. 39 shows the 2000 Lotito Musical Notation System from U.S. Pat. No. 6,124,540.

FIG. 40 shows the 2014 West et al. Music Notation System from U.S. Pat. No. 8,916,760 B1.

FIG. 41 shows the 2001 Fajardo Musical Notation System from U.S. Pat. No. 6,288,316 B1.

FIG. 42 shows the 2008 Mataele Method and System for Music Notation from patent application US 2008/0202318 A1.

FIG. 43 shows the 2002 Bermudez Method and Apparatus for Teaching Music U.S. Pat. No. 6,388,182 B1.

FIG. 44 shows the 2010 Johnston Music Notation System from U.S. Pat. No. 7,767,895 B2.

FIG. 45 shows the 2014 King Piano Tablature System and Method from U.S. Pat. No. 8,835,737 B2.

FIG. 46 shows the commercially available Willis Keyboard and Reference Chart.

FIG. 47 shows the comparison of the various size keyboards (24-88 keys) aligned with a reference 44 note Grand Staff.

### DETAILED DESCRIPTION OF THE INVENTION

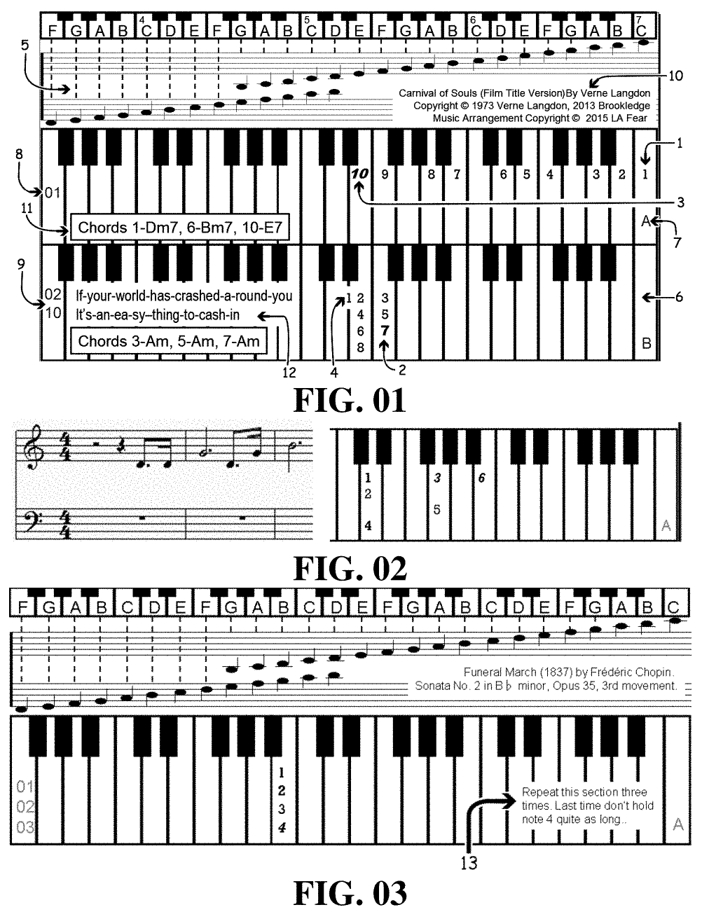

This invention is a music notation system that simplifies learning and playing by eliminating traditional sheet music by using images of keyboards with numbers placed on them to indicate the order keys are pressed by the right hand (FIG. 01). You press the keys in order, so the key with the number one on it is pressed and released, and then the key with the number 2 is pressed and released and so on (FIG. 01-1). A numbers can be printed plain, bold (FIG. 01-2) or bold-italic (FIG. 01-3) to indicate to hold it a short, long or longer time amount of time (FIG. 01-2). When a number is printed on the line separating the white keys (FIG. 01-4) you play the black key above the line. The top of the first page of a song typically has a 44 note grand staff (FIG. 01-5) and keyboard images aligned below (FIG. 01-6). This piece of music is broken into chunks (a melodic phrase). The chunk is played until mastered. Then you move on to the next chunk. Each chunk is identified with a letter (A, B, C, . . . ) on the right side (FIG. 01-7). The left side has a number indicating the order (01, 02, 03, . . . ) a chunk is played (FIG. 01-8). Sometimes a chunk is played multiple times so the left side may have more than one number (FIG. 01-9). Song title, composers and copyright information is listed in the grand staff on the first page of each song (FIG. 01-10). Chords can be listed in a call out box preceded by a number (1-Dm7, 6-Bm7, . . . ) indicating that chord is played at the same time as note 1 (FIG. 01-11). Lyrics are aligned with the numbering on the left side (FIG. 01-12).

The best way to understand the simplicity of playing a song using this invention is to look at music in traditional sheet music side by side with the invention (FIG. 02). This is the first chunk of the song “Taps”. Both show the same 6 notes. The dotted quarter notes are replaced with bold numbers. The dotted half notes is replaced with a bold-italic number

Rather than Latin or Italian instructions for playing (repeats and intensity) will be given in English (FIG. 03-13).

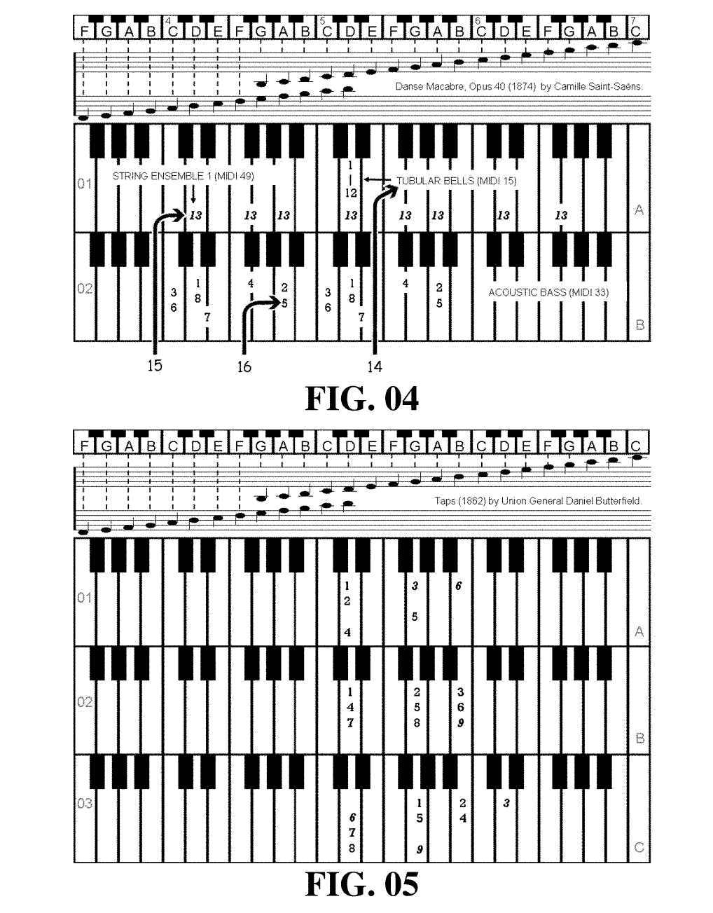

Some songs sound best with particular instruments so for MIDI keyboards particular voices are called out (FIG. 04-14). Chords can also simply be designated by a number appear on a keyboard image more than once (FIG. 04-15). The same plain, bold, bold-italic rules apply regarding length of notes applies to the chords (FIG. 04-16).

A best example of this invention can bee seen in the music for the song “Taps” by Union General Daniel Butterfield (FIG. 05). This song has no lyrics and three chunks. We can clearly see the three chunks of the song (A, B, C) and the numbers for the chunks (01, 02, 03) that indicate they are played only once.

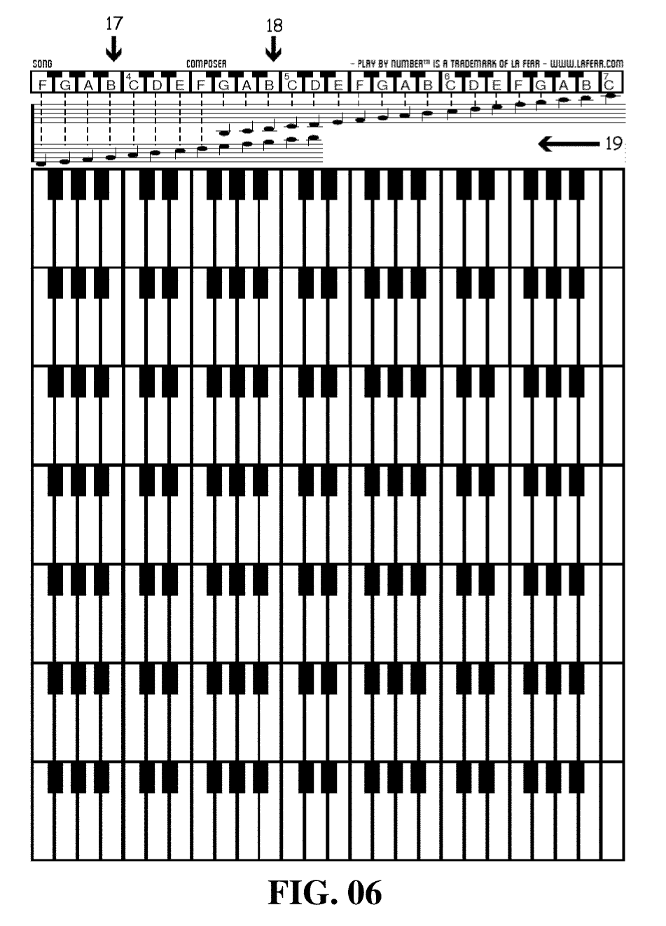

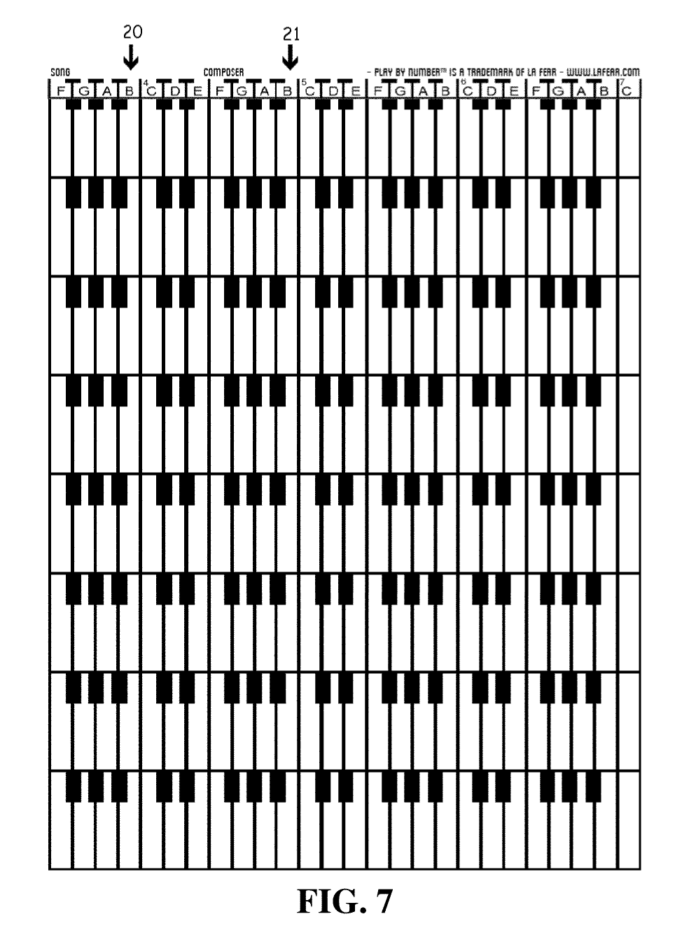

When this notation is used in a book the top of the first page of the song has the 44 key grand staff with the song title on top (FIG. 06-17), the composer (FIG. 06-18) and in a narrative form the song title, composers and copyright information is listed in the grand staff on the first page of each song (FIG. 06-19). For the subsequent pages only the song title (FIG. 07-20) and composer (FIG. 07-21) is listed.

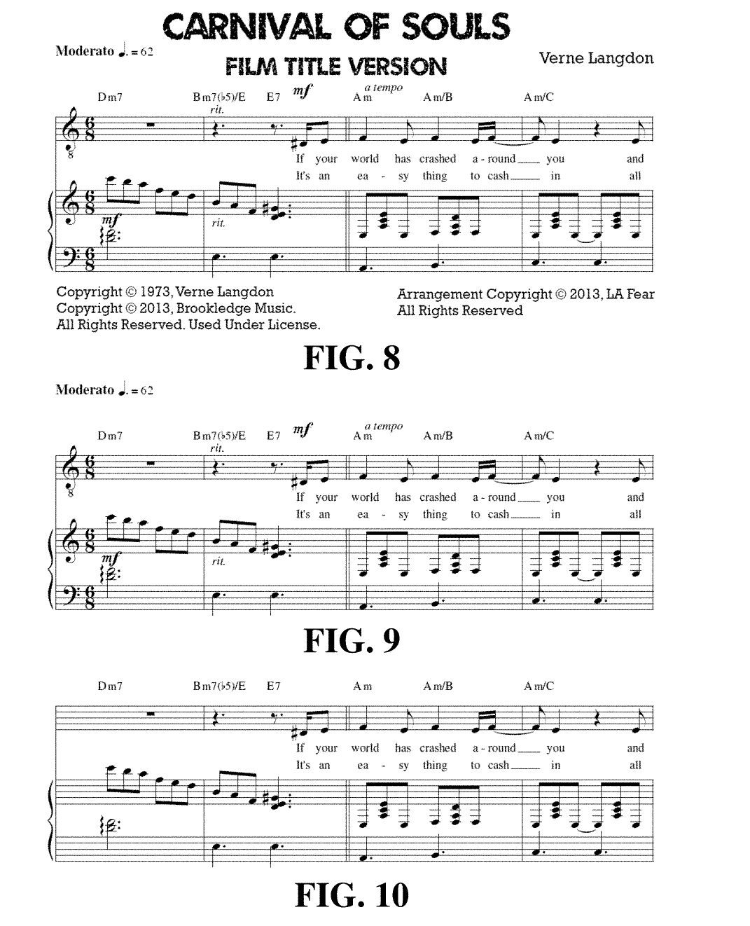

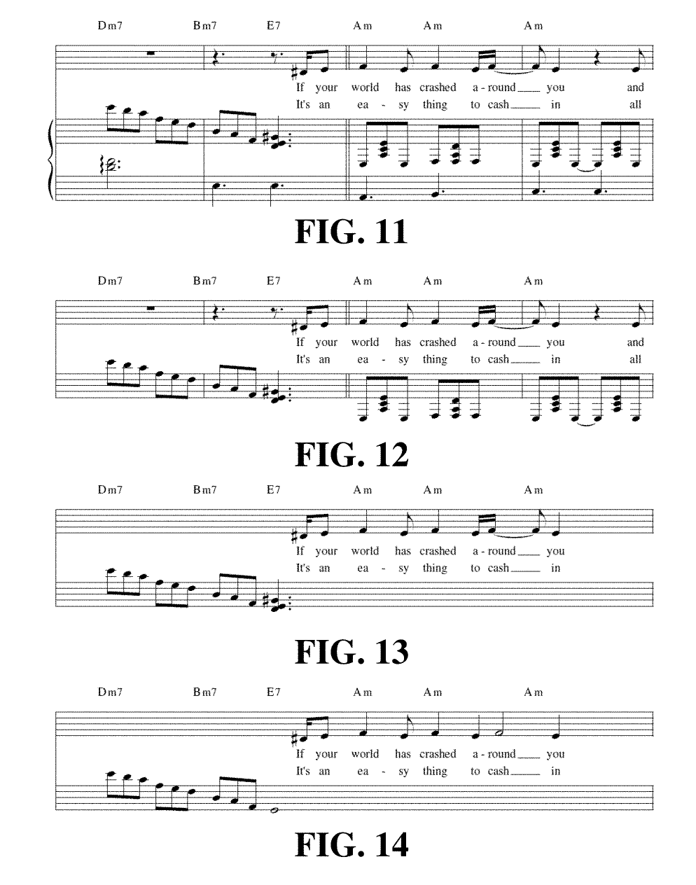

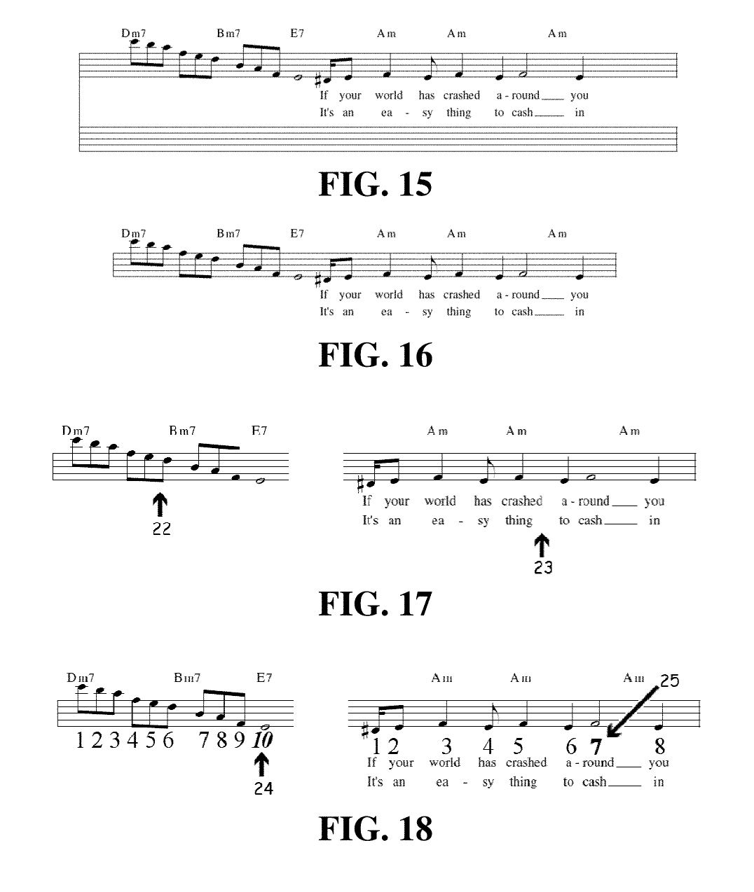

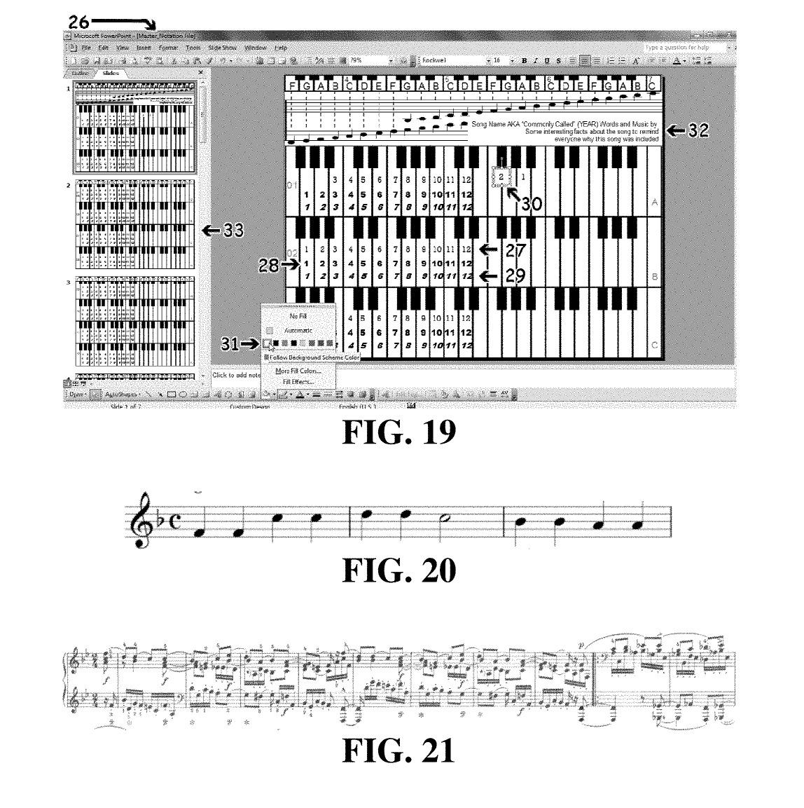

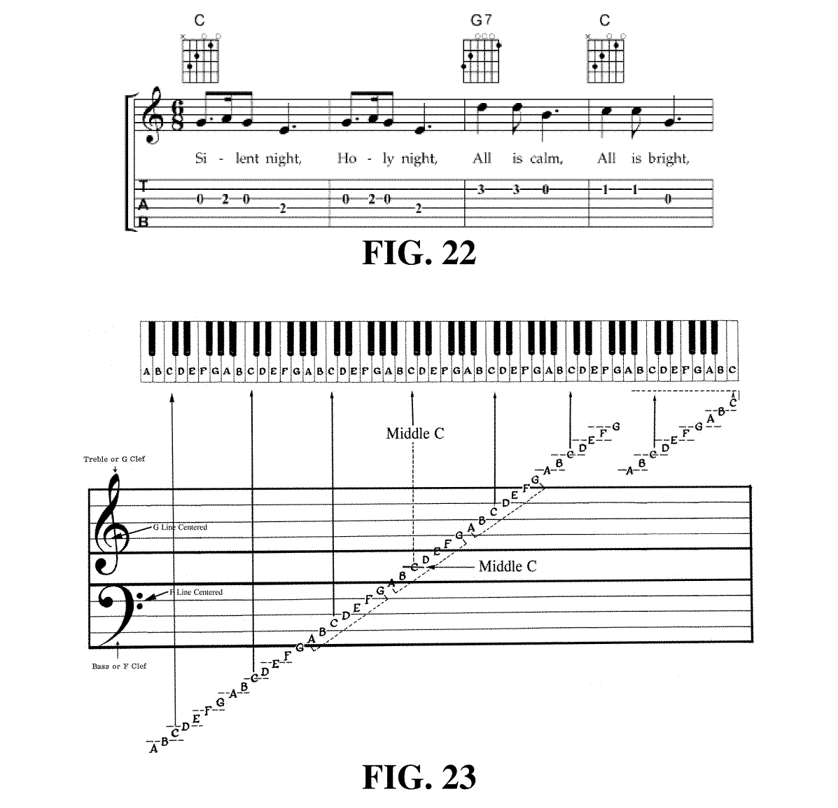

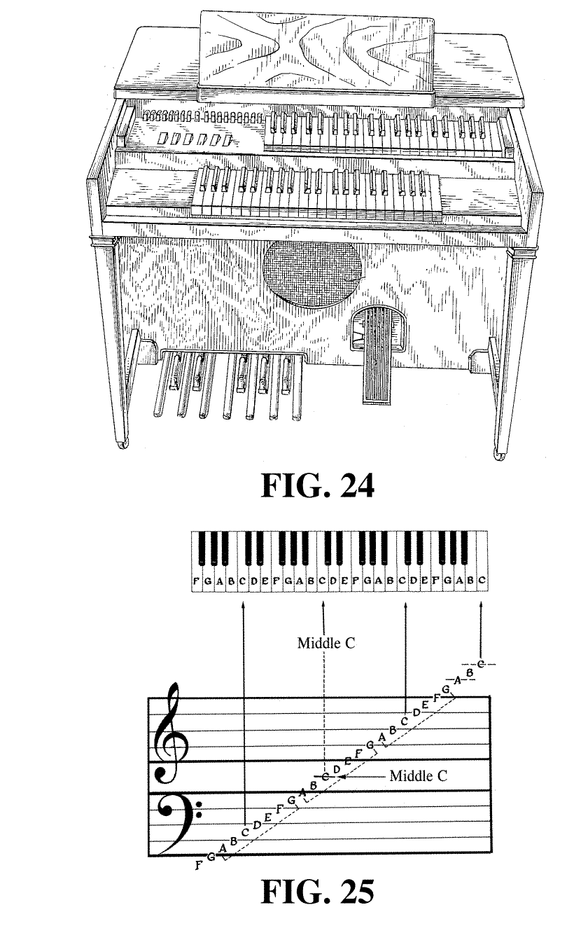

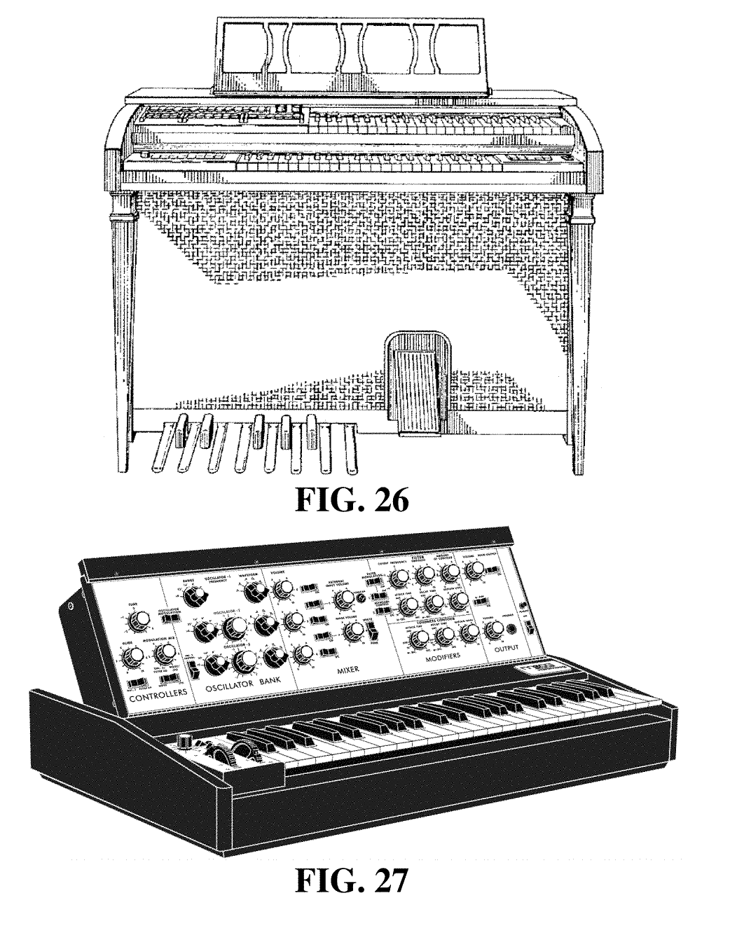

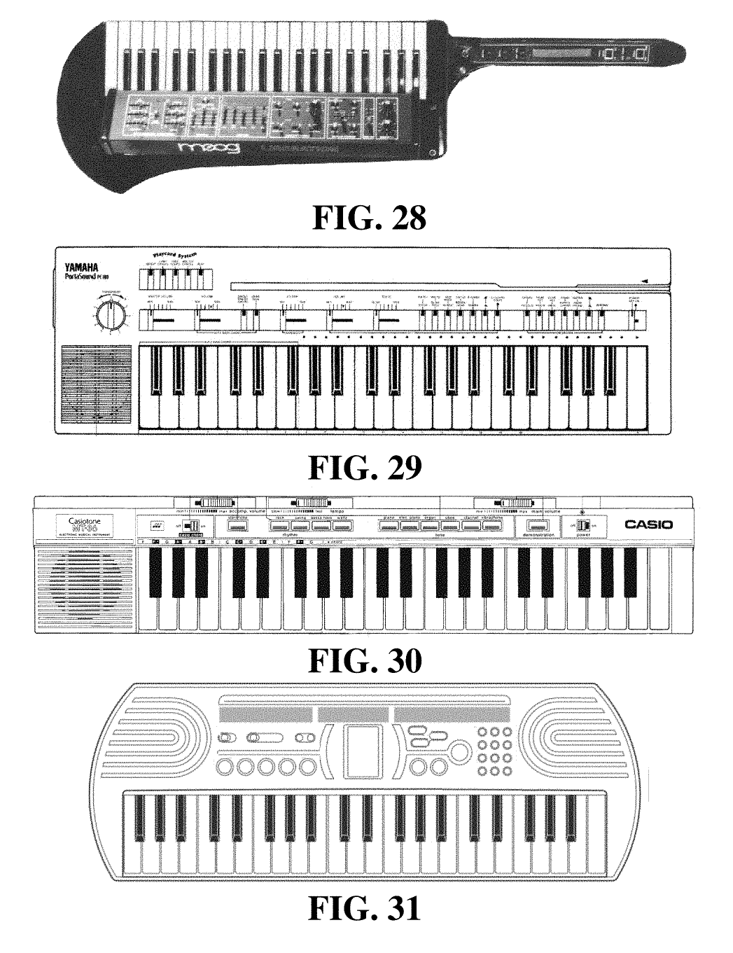

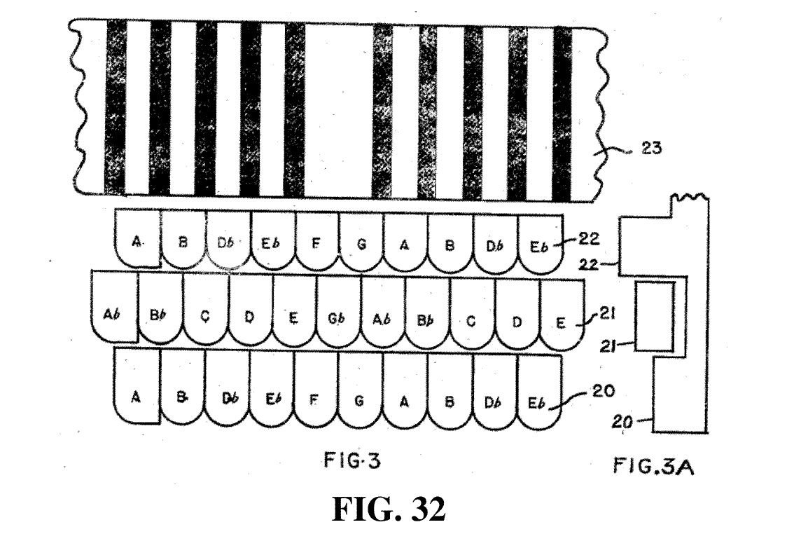

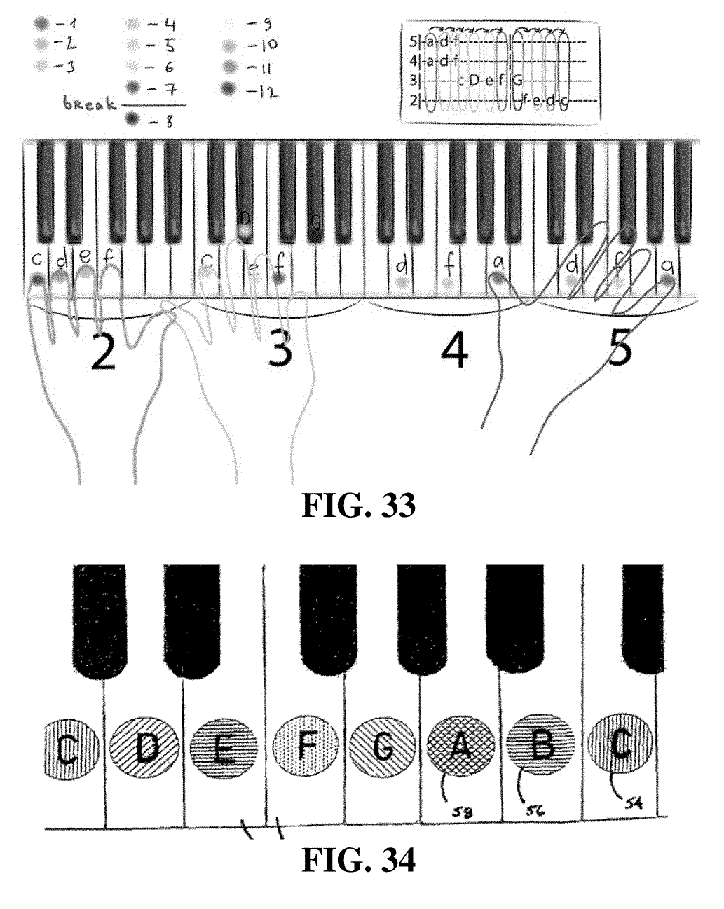

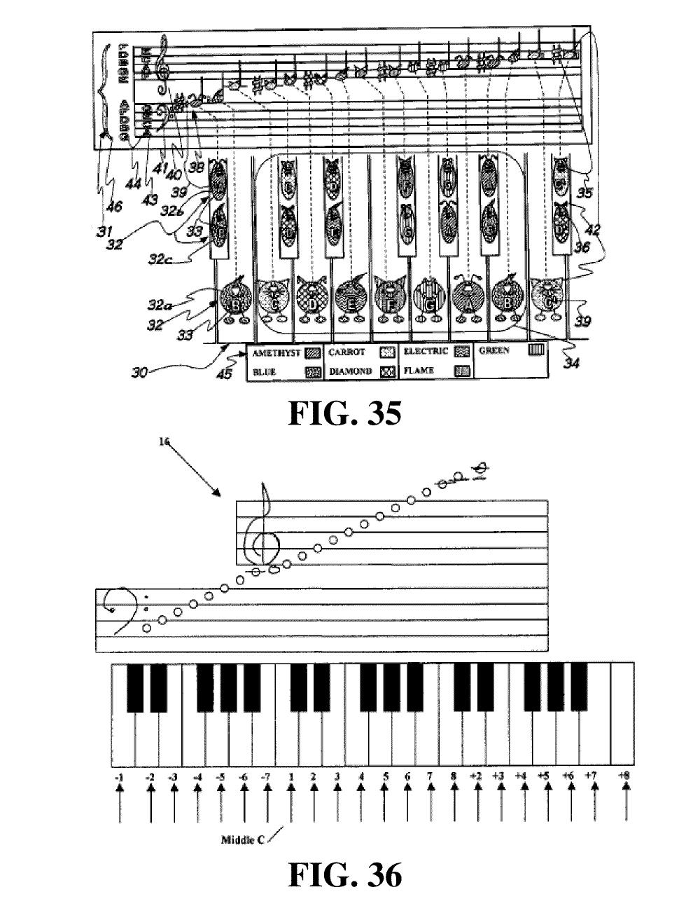

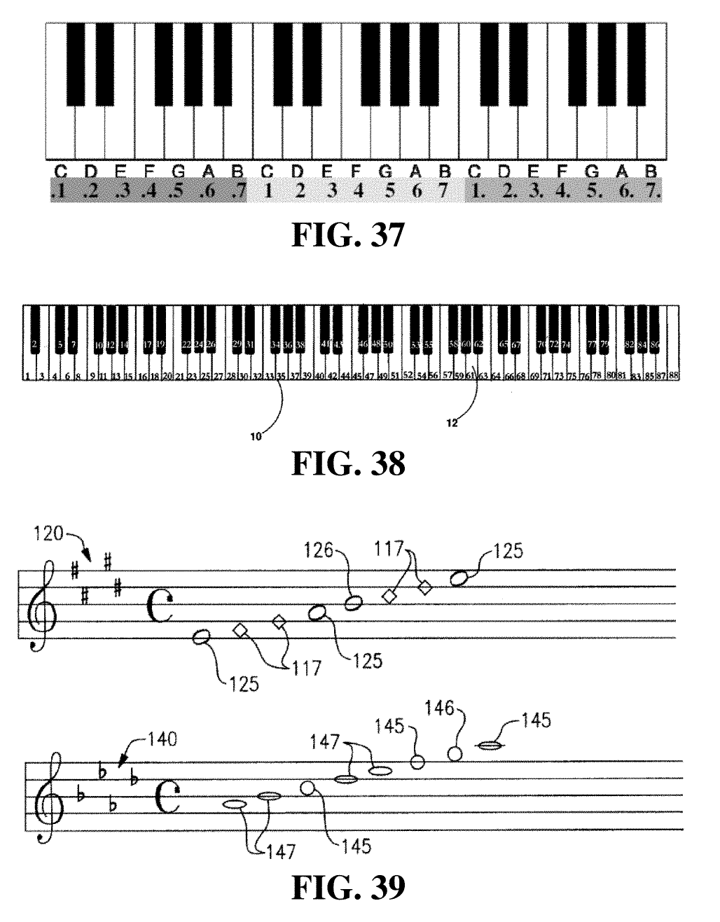

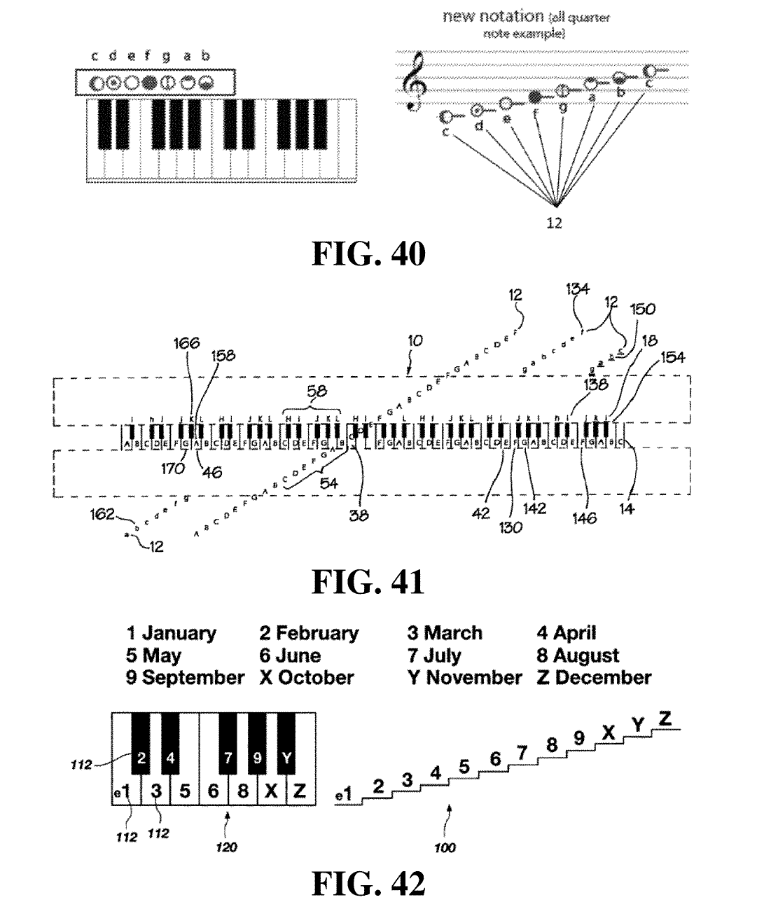

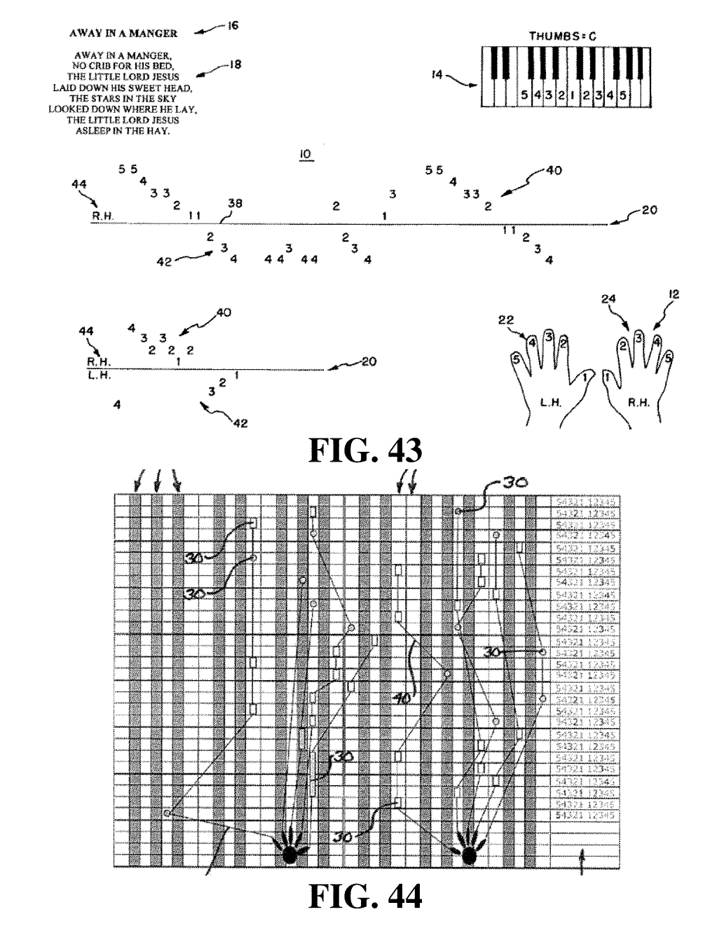

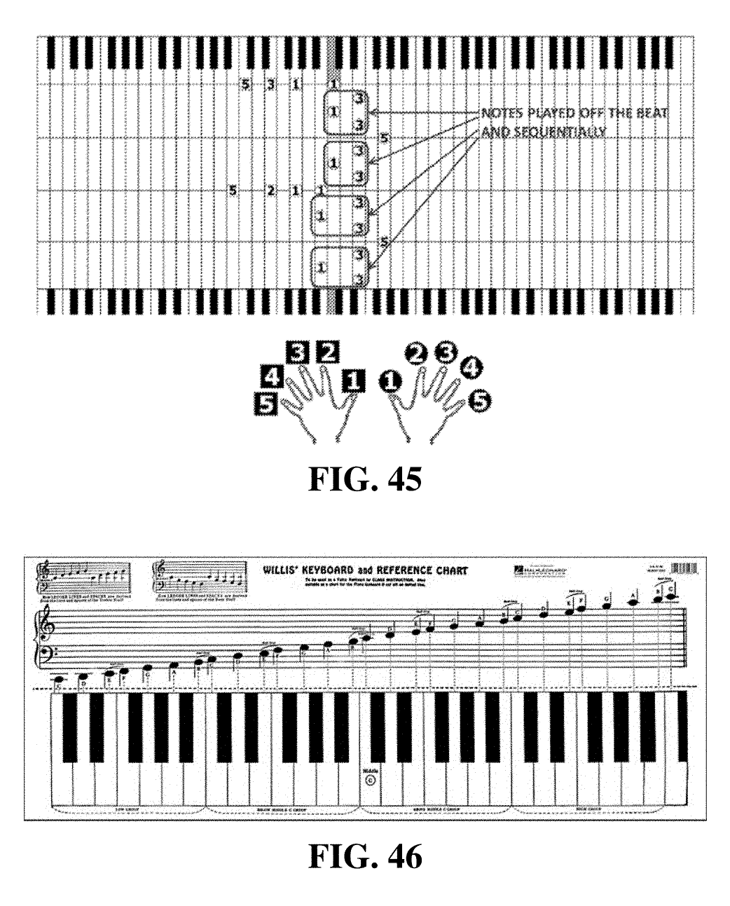

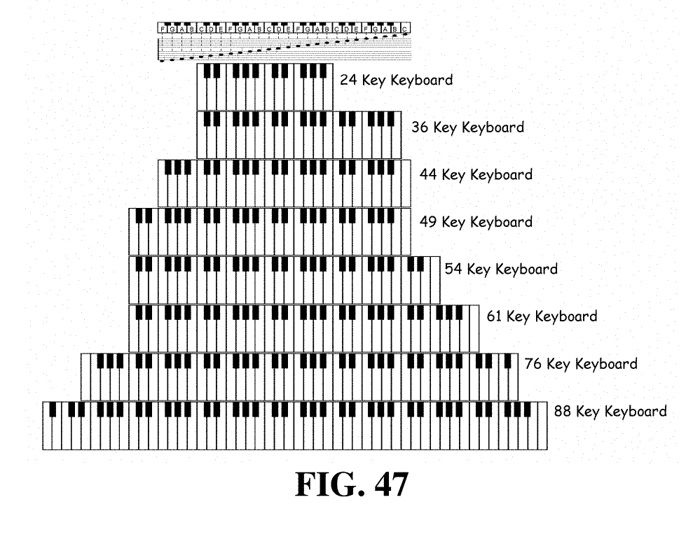

To create the notation for this invention we usually start with existing traditional sheet music (FIG. 8). Remove the title (FIG. 9). Remove the Tempo and Latin instructional words (FIG. 10). Simplify the chords (FIG. 11). Remove left hand (bottom) staff (FIG. 12). Remove right notes and rests that clash with the melody (FIG. 13). Reduce notes (FIG. 14). Combine staffs (FIG. 15). Remove bottom staff (FIG. 16) Break music into chunks (a melodic phrase) (FIGS. 17-22 and 17-23). Number notes beginning with 1 in each chunk (FIGS. 18-24 and 18-25). Once the sung is placed in this notation method a consumer can use blank pages (FIGS. 6 and 7) to record the new notation. Professionally produced music books using this notation are created with a computer system (FIG. 19-26) starting with blank sections of the page and collections of plain (FIG. 19-27, bold (FIG. 19-28) and bold-italic numbers (FIG. 19-29). Numbers are dragged into position (FIG. 19-30) and formatted (FIG. 19-31). Title, composer and copyright information is entered (FIG. 19-32). Additional sections of the song are created from the templates (FIG. 19-33) until the song is completed and can be printed.

This invention is superior to traditional sheet music due to its visual representation of the keyboard with the numbers located on the keys to press. No learning the staff. It is also superior due to the simplicity of relative note lengths (short, long and longest) that allow novice learns (who by their nature play slower) to adjust the note lengths to match their speed.

This invention is superior to all methods like the 1946 Firestone Music Teaching Device because you do not have to replace your existing keyboard instruments to use it.

This invention is superior to all of the color coding methods like the 2005 MacCutcheon Music Teaching System because of the lower cost of black and white printing and because color coding methods require you to place stickers on your keyboard.

This invention is superior to the method of keyboard numbering described in the 2007 Egan Morpheus Music Notation due to the complexity of memorizing 88 key locations required by this system and the need to label all 88 keys.

This invention is superior to the changing the note shape methods like the 2000 Lotito Musical Notation System due to the fact in order to understand the changing note shapes you need to understand how to read sheet music where this invention eliminates this requirement.

This invention is superior to methods where you rename the sharps and flats like the 2001 Fajardo Musical Notation System due to need to memorize the location on the keyboard to note “K” or note “Y”. No memorization is needed for this invention.

This invention is superior to the finger numbering methods like the 2014 King Piano Tablature System and Method due to the complexity of the time component of these systems (the need to keep a beat) and the need to keep track of what all 5 fingers on each hand is doing.

This invention is superior to any reference chart because you are not using the chart to figure out what sheet music means, you are using the invention to see what key to press.

This invention is superior to all other methods because it allows a user to quickly understand what key to press for the next note in the song allowing for the quick accomplishment of playing a song.

1. A music notation system comprising:
(a) Multiple images of piano/organ keyboards placed on a page.
(b) Grand staff placed at above the images aligned to the keys in the image.
(c) Numbers starting with one are placed on the white keys of each keyboard image to indicate the order in which to press the keys.
(d) The style of the number [plain, bold, bold-italic] indicates the relative length of time to hold the key [short, long, longer].
(e) Numbers placed on the line separating the white keys indicates to play the black key above.
(f) A number appearing more than once on an individual keyboard image indicates to play both/several keys at once.
(g) Said system shall be claimed for the 44 key version illustrated. Additionally claim extends to the following sized keyboards:
24 Key, 25 Key, 36 Key, 48 Key, 49 Key, 54 Key, 61 Key, 72 Key and 88 Key.
A method of creating such music notation by:
(a) Removing Title
(b) Removing Tempo and Latin instructional words
(c) Simplifying Chords
(d) Remove Left Hand (Bottom) Staff
(e) Remove Right Notes and Rests that clash with the Melody
(f) Reduce Notes
(g) Combine Staffs
(h) Remove Bottom Staff
(i) Break Music into Chunks (a melodic phrase)
(j) Number Notes beginning with 1 in each Chunk
(k) Transferring information manually onto a blank Play By Number Notation System Form or editing a Master Play By Number Notation System Form on a computer for printing.
A method of instruction in playing music on the keyboard by:
(a) Placing the Play By Number Notation above the keyboard.
(b) Looking at the image of the first keyboard [the one with the letter A on the right hand side] locate which key has the number 1 placed on it.
(c) Determining if the number 1 is plain, bold or bold-italic to know whether to play it short, long or longer respectively.
(d) Determine if number 1 appears more than one time on the keyboard. If it does you press all the keys with the number 1 on them for the same amount of time and release at the same time.
(d) Continue playing until you have played all the numbers on the keyboard.
(e) Repeat steps a-d until you have mastered this chunk of the song.
(f) Note the gray numbers 01 on the left hand side. This is the order (1, 2, 3, 4, . . . ) that the chunks (A,B,C) are played.
(g) Repeat on the next chunk until all are played.
